(19) United States
(12) Patent Application Publication
(10) Pub. No.: US 2008/0138134 A1
(43) Pub. Date: Jun. 12, 2008

(54) Keyboard assembly with integral air circulator

(76) Inventor: Wendy J. Wilde, Holmen, WI (US)

Correspondence Address: IPA, STE. 101, 400 GARDEN CITY PLAZA, GARDEN CITY, NY, 11530, US

(21) Appl. No.: 11/634,911

(22) Filed: Dec. 7, 2006

(51) Int. Cl. B41J 5/00

(52) U.S. Cl. 400/472

(57) ABSTRACT

A keyboard assembly comprises a housing structure and an air circulator apparatus attached to the housing structure. The housing structure has an interior space therein, a key opening within a housing wall thereof and at least one key movably extending through the key opening whereby a gap is provided between the key opening and the at least one key. The air circulator apparatus includes an air circulation device having an air inlet portion and an air outlet portion. The air inlet portion receives substantially an entire portion of air circulated by the air circulation device from outside of the housing structure and the air exits the air outlet portion into the interior space of the housing structure such that the interior space of the housing structure is pressurized thereby causing the air to flow though the gap provided between the key opening and the at least one key.

### FIELD OF THE DISCLOSURE

The disclosures made herein relate generally to computer systems and computer system components and, more particularly, to keyboard assemblies for computer systems.

### BACKGROUND

When using one's hands, they are often at an uncomfortable temperature. If one's hands are cold, one usually wears gloves. However, when using a device such as a keyboard, wearing gloves reduces finger sensitivity and accuracy to a degree that gloves are not practical to wear when typing. Conversely, if one's hands are warm, one usually cools them with moving air. However, when using a keyboard, the air around the keyboard is stationary, and often warm from the heat of the computer (especially if the computer is integral with the keyboard (e.g., a laptop computer). Therefore, a keyboard assembly incorporating a device that warms or cools one's hands when typing would be advantageous, desirable and useful.

### SUMMARY OF THE DISCLOSURE

Embodiments of a keyboard assembly in accordance with the present invention provide for heating and/or cooling of a keyboard user's hands typing on keys of the keyboard assembly. In one embodiment of the present invention, a keyboard assembly comprises a housing structure and an air circulator apparatus attached to the housing structure. The housing structure has an interior space therein, a key opening within a housing wall thereof and at least one key movably extending through the key opening whereby a gap is provided between the key opening and the at least one key. The air circulator apparatus includes an air circulation device having an air inlet portion and an air outlet portion. The air inlet portion receives substantially an entire portion of air circulated by the air circulation device from outside of the housing structure and the air exits the air outlet portion into the interior space of the housing structure such that the interior space of the housing structure is pressurized thereby causing the air to flow though the gap provided between the key opening and the at least one key.

In another embodiment of the present invention, a keyboard assembly comprises a housing structure and an air circulator apparatus attached to the housing structure. The housing structure has an interior space therein, a plurality of key openings within a housing wall thereof and a least one key movably extending through each one of the key opening whereby a gap is provided between each one of the key openings and the at least one key extending through each one of the key openings. The air circulator apparatus includes an air circulation device having an air inlet portion and an air outlet portion. The air inlet portion receives substantially an entire portion of air circulated by the air circulation device from outside of the housing structure and. The air exits the air outlet portion into the interior space of the housing structure such that the interior space of the housing structure is pressurized thereby causing the air to flow though the gap provided between each one of the key openings and the at least one key extending through each one of the key openings. The air circulation apparatus includes a temperature control device for selectively causing a temperature of the air to be one of substantially higher than an ambient air temperature and substantially lower than the ambient air temperature.

In another embodiment of the present invention, a keyboard assembly comprises a housing structure and means for heating the keys. The housing structure has an interior space therein, a plurality of key openings within a housing wall thereof and a plurality of keys movably extending through each one of the key openings whereby a gap is provided between each one of the key openings and respective ones of the keys. The means for heating includes generating pressurized heated air for causing the pressurized heated air to flow past at least a portion of the keys and through the gap provided between the key opening and the at least one key.

Turning now to specific aspects of the present invention, in at least one embodiment, an air circulation apparatus includes a temperature control device for selectively causing a temperature of air to be one of substantially higher than an ambient air temperature and substantially lower than the ambient air temperature.

In at least one embodiment of the present invention, a housing structure includes at least one air inlet opening therein and substantially the entire portion of the air circulated by an air circulation device flows through the at least one air inlet opening.

In at least one embodiment of the present invention, an entire portion of the air circulated by the air circulation device flows through the at least one air inlet opening directly into an inlet air portion of the air circulation device.

In at least one embodiment of the present invention, an air circulator apparatus includes a power supply plug through which electrical power is supplied from an external power source to an air circulation device.

In at least one embodiment of the present invention, an air circulator apparatus includes a manually-operated switch accessible at an exterior surface of a housing structure and the manually-operated switch is electrically connected between a power supply plug and an air circulation device for enabling power to be selectively supplied to the air circulation device from an external power source.

In at least one embodiment of the present invention, a manually-operated switch, at least one air inlet opening and a key opening are provided in a common face of a housing structure.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 is a perspective view showing an embodiment of a keyboard assembly configured in accordance with the present invention.

FIG. 2 is a cross-sectional view taken along the line 2-2 in FIG. 1.

FIG. 3 is a block diagram showing the relationship between major electrical components of the keyboard assembly of FIG. 1.

### DETAILED DESCRIPTION OF THE DRAWING FIGURES

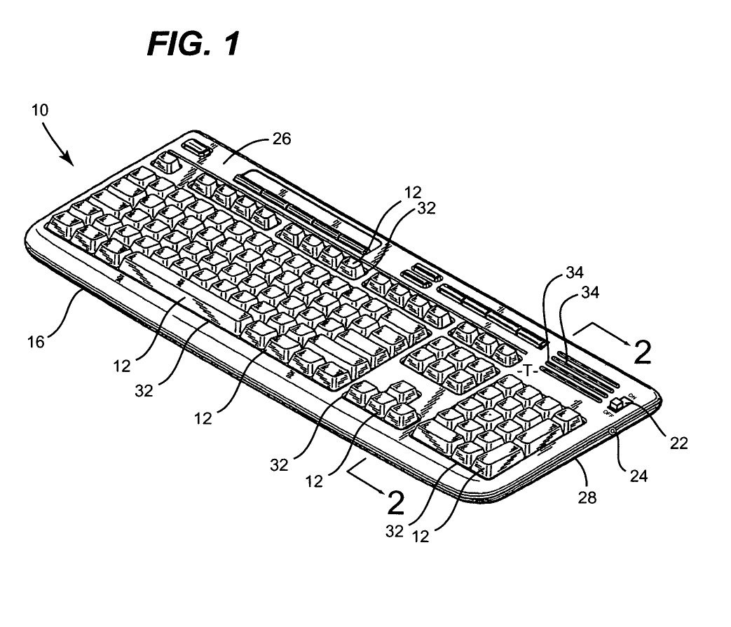

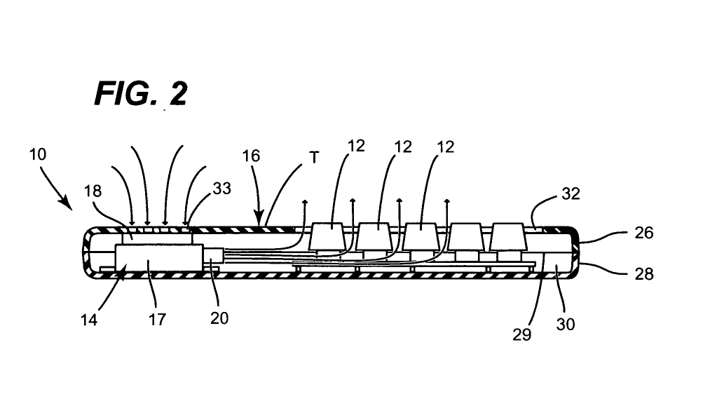

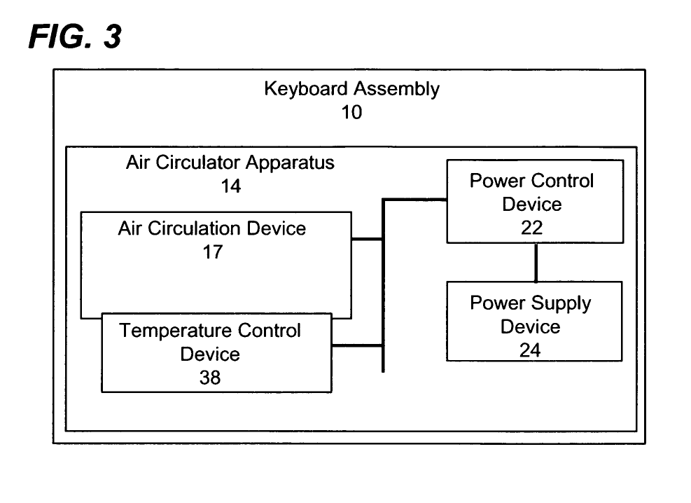

FIGS. 1-3 show an embodiment of a keyboard assembly in accordance with the present invention, which is referred to herein as the keyboard assembly 10. The keyboard assembly 10 includes a plurality of keys 12 and an air circulator apparatus 14 (FIGS. 2 and 3). The keys 12 and the air circulator apparatus 14 are attached to a keyboard housing 16 of the keyboard 10. The air circulator apparatus 14 includes an air circulation device 17, an air inlet 18 portion, an air outlet portion 20, a power control device 22 (e.g., a switch), and a supply device 24.

Referring to FIGS. 2 and 3, the keyboard housing 16 includes a top portion 26 and a bottom portion 28, which are fixedly joined at a respective interface thereof (i.e., interface 29, FIG. 2) such that the keyboard housing 16 provides an interior space 30. As depicted, the keys 12 are fixedly attached to the bottom portion 28 of the keyboard housing 16. However, it is disclosed herein that the keys 12 may be attached to the bottom portion 28 and/or top portion 26 of the keyboard housing 16. The keys 12 protrude through respective key openings 32 in the top portion 26 of the keyboard housing 16. The air outlet portion 20 of the air circulation device 17 is located within the interior space 30 of the keyboard housing 16. The air inlet portion 18 of the air circulation device 17 is positioned behind air inlet openings 33 in a top face T of the top portion 28 of the keyboard housing. Optionally, the air inlet portion 18 and the air inlet openings are positioned in a side face or bottom face of the keyboard housing.

Air (represented as arrows 34) is drawn through the inlet portion 18 of the air circulation device 17 and is forced through the outlet portion 20. In one embodiment, the air circulation device includes a pressure-creating device such as a fan assembly or a blower assembly, thus enabling the air to flow into the air inlet portion 18 and out of the air outlet portion 20. In this manner, the air circulation causes the air within the interior space 30 of the keyboard housing 16 to be pressurized, thereby resulting in the air 34 being forced out of the keyboard housing 16 through the gaps between the keys 12 and the edges of the key openings 32. Accordingly, while using the keyboard 10, the air 34 contacts the hands of a user.

It is disclosed herein that, in other embodiments of the present invention (not specifically shown), an air duct structure is provided within the interior space 30 of the keyboard housing 16. The air outlet portion 20 of the air circulation device 17 is connected to an air inlet portion of the air duct structure. In this manner, air is forced into the air inlet portion of the air duct structure and flows out of an air outlet portion of the air duct structure. The air outlet portion of the air duct structure is positioned behind one or more air outlet openings in the keyboard housing such that the air flows through such air outlet openings in the keyboard housing.

Referring now to FIGS. 1-3, electric power is provided to the air circulator apparatus 17 via the power supply device 24. Power is routed through the power control device 22 for enabling electrical power to be selectively provided to the air circulation device 17. As shown in FIG. 1, the power supply device 24 is a power supply plug through which electrical power is supplied from an external power source and the power control device 22 is a manually-operated switch accessible at an exterior surface of the housing structure 16. Examples of the external power source include, but are not limited to, a standalone AC-DC power supply apparatus and a power supply of a computer system central processing unit. In other embodiments of the present invention, the power supply device 24 includes an AC-DC power supply apparatus or a battery pack, such that a utilized voltage level is provided for within the keyboard housing 16. Alternatively, in one embodiment of the present invention, the computer to which the keyboard 10 is connected supplies electrical power (e.g., via a USB cable).

A temperature control device 38 (FIG. 3) enables temperature of the air 34 from the outlet 20 may be regulated. In one embodiment, the temperature control device 38 includes an air heater and/or an air cooler such that the air 34 can be heated and/or cooled as it passes through the air circulation device 17. The temperature control device 38 causing a temperature of the air 34 to be selectively substantially higher than an ambient air temperature or substantially lower than the ambient air temperature. Examples of devices for altering temperature of the air 34 (i.e., a heating device and/or a cooling device) include, but are not limited to, a Peltier device, resistive heating elements and an air conditioning unit (e.g., compressor with refrigerant). In one embodiment, the temperature control device 38 includes a thermostat that serves to maintain the air 34 as a prescribed temperature at the air outlet portion 20 of the air circulation device 17. The prescribed temperature may be a fixed prescribed temperature, a temperature manually selected from a range of selectable temperatures or a temperature automatically selected from a range of selectable temperatures based on an ambient temperature surrounding the keyboard housing 16. The thermostat may be of a mechanical-type (e.g., bimetal spring and mercury switch) or electrical-type (e.g., thermistor).

Alternatively, an air circulation apparatus in accordance with the present invention may be integral with components of a laptop computer. It is contemplated and disclosed herein that the means to alter the temperature of the air 34 may be combined with other components of a computer system. In one embodiment of the present invention, an air circulator apparatus in accordance with the present invention is integral with a laptop computer and air circulated by the air circulator apparatus includes air used to cool system components (e.g., processor, disk drive, etc) of the laptop computer. As a skilled person will understand, a laptop computer includes a keyboard assembly comprising a housing structure and a plurality of keys as well as other computer system components (e.g., a processor, a disk drive, memory, etc). It is further disclosed herein that the air circulator apparatus may be integral with fan assembly used for cooling the system components of the laptop computer (e.g., an air circulation device of the air circulator apparatus is integral with a processor cooling fan assembly). In this manner, the air circulated by an air circulator apparatus is warmed by the system component(s) of the laptop computer.

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A keyboard assembly, comprising:
a housing structure having an interior space therein, a key opening within a housing wall thereof and at least one key movably extending through the key opening whereby a gap is provided between the key opening and said at least one key;
an air circulator apparatus attached to the housing structure, wherein the air circulator apparatus includes an air circulation device having an air inlet portion and an air outlet portion and wherein the air inlet portion receives substantially an entire portion of air circulated by the air circulation device from outside of the housing structure and said air exits the air outlet portion into the interior space of the housing structure such that the interior space of the housing structure is pressurized thereby causing said air to flow though the gap provided between the key opening and said at least one key.

2. The keyboard assembly of claim 1 wherein the air circulation apparatus includes a temperature control device for selectively causing a temperature of said air to be one of substantially higher than an ambient air temperature and substantially lower than the ambient air temperature.

3. The keyboard assembly of claim 1 wherein:
the housing structure includes at least one air inlet opening therein; and
substantially the entire portion of said air circulated by the air circulation device flows through said at least one air inlet opening.

4. The keyboard assembly of claim 1 wherein the entire portion of said air circulated by the air circulation device flows through said at least one air inlet opening directly into an inlet air portion of the air circulation device.

5. The keyboard assembly of claim 1 wherein air circulator apparatus includes a power supply plug through which electrical power is supplied from an external power source to the air circulation device.

6. The keyboard assembly of claim 5 wherein:
an air circulator apparatus includes a manually-operated switch accessible at an exterior surface of the housing structure, and
the manually-operated switch is electrically connected between the power supply plug and the air circulation device for enabling power to be selectively supplied to the air circulation device from the external power source.

7. The keyboard assembly of claim 6 wherein the manually-operated switch, said at least one air inlet opening and the key opening are provided in a common face of the housing structure.

8. The keyboard assembly of claim 7 wherein the air circulation apparatus includes a temperature control device for selectively causing a temperature of said air to be one of substantially higher than an ambient air temperature and substantially lower than the ambient air temperature.

9. The keyboard assembly of claim 7 wherein:
the housing structure includes at least one air inlet opening therein; and
substantially the entire portion of said air circulated by the air circulation device flows through said at least one air inlet opening.

10. The keyboard assembly of claim 7 wherein the entire portion of said air circulated by the air circulation device flows through said at least one air inlet opening directly into an inlet air portion of the air circulation device.

11. A keyboard assembly, comprising:
a housing structure having an interior space therein, a plurality of key openings within a housing wall thereof and a least one key movably extending through each one of said key opening whereby a gap is provided between each one of said key openings and said at least one key extending through each one of said key openings;
an air circulator apparatus attached to the housing structure, wherein the air circulator apparatus includes an air circulation device having an air inlet portion and an air outlet portion, wherein the air inlet portion receives substantially an entire portion of air circulated by the air circulation device from outside of the housing structure, wherein said air exits the air outlet portion into the interior space of the housing structure such that the interior space of the housing structure is pressurized thereby causing said air to flow though the gap provided between each one of said key openings and said at least one key extending through each one of said key openings and wherein the air circulation apparatus includes a temperature control device for selectively causing a temperature of said air to be one of substantially higher than an ambient air temperature and substantially lower than the ambient air temperature.

12. The keyboard assembly of claim 11 wherein:
the housing structure includes at least one air inlet opening therein; and
substantially the entire portion of said air circulated by the air circulation device flows through said at least one air inlet opening; and
the entire portion of said air circulated by the air circulation device flows through said at least one air inlet opening directly into an inlet air portion of the air circulation device.

13. The keyboard assembly of claim 12 wherein air circulator apparatus includes a power supply plug through which electrical power is supplied from an external power source to the air circulation device.

14. The keyboard assembly of claim 13 wherein:
an air circulator apparatus includes a manually-operated switch accessible at an exterior surface of the housing structure;
the manually-operated switch is electrically connected between the power supply plug and the air circulation device for enabling power to be selectively supplied to the air circulation device from the external power source; and
the manually-operated switch, said at least one air inlet opening and the key opening are provided in a common face of the housing structure.

15. A keyboard assembly, comprising:
a housing structure having an interior space therein, a plurality of key openings within a housing wall thereof and a plurality of keys movably extending through each one of said key openings whereby a gap is provided between each one of said key openings and respective ones of said keys; and
means for heating said keys, wherein said means for heating includes generating pressurized heated air for causing said pressurized heated air to flow past at least a portion of said keys and through the gap provided between the key opening and said at least one key.

16. The keyboard assembly of claim 15 wherein said means pressurizes air within the interior space of the housing structure thereby enabling said air to flow though the gap provided between the key opening and said at least one key.

17. The keyboard assembly of claim 15 wherein:
said means for heating said keys includes an air circulator apparatus attached to the housing structure;
the air circulator apparatus includes an air circulation device having an air inlet portion an air outlet portion; and
the air inlet portion receives substantially an entire portion of air circulated by the air circulation device from outside of the housing structure and said air exits the air outlet portion into the interior space of the housing structure such that the interior space of the housing structure is pressurized thereby causing said air to flow though the gap provided between the key opening and said at least one key.

18. The keyboard assembly of claim 17 wherein:
the housing structure includes at least one air inlet opening therein; and
substantially the entire portion of said air circulated by the air circulation device flows through said at least one air inlet opening; and
the entire portion of said air circulated by the air circulation device flows through said at least one air inlet opening directly into an inlet air portion of the air circulation device.

19. The keyboard assembly of claim 18 wherein air circulator apparatus includes a power supply plug through which electrical power is supplied from an external power source to the air circulation device.

20. The keyboard assembly of claim 19 wherein:
an air circulator apparatus includes a manually-operated switch accessible at an exterior surface of the housing structure;
the manually-operated switch is electrically connected between the power supply plug and the air circulation device for enabling power to be selectively supplied to the air circulation device from the external power source; and
the manually-operated switch, said at least one air inlet opening and the key opening are provided in a common face of the housing structure.
